(19) United States
(12) Patent Application Publication
(10) Pub. No.: US 2012/0269946 A1
(43) Pub. Date: Oct. 25, 2012

(54) Method for the pasteurization of wine on a production basis in the winery

(76) Inventor: Cornelius Peter Medaglia, Chatham, VA (US)

(21) Appl. No.: 13/066,693

(22) Filed: Apr. 22, 2011

(51) Int. Cl. C12H 1/00; C12G 1/00

(52) U.S. Cl. 426/521

(57) ABSTRACT

Attaining biological stability in wine has been a problem for winemakers for centuries. The main methods for preventing microbes from destroying wine have been the addition of chemicals such as sulphur dioxide and potassium sorbate and ultra filtration. These methods are less than satisfactory. Chemicals can only be used to a certain level before they affect the taste of the wine or cause allergy reactions in the drinker. Ultra filtration will remove the microbes but it also removes taste and body from the wine. Previous attempts at pasteurization of wine have been marginally successful because of the subsequent spoilage of the wine in less than optimum winery storage and less than total kill of the microbes. I have devised a method to eliminate these problems and have the wine ready to bottle in a pasteurized state, and designed the equipment to do this in the winery. The method consists of two elements which differ from previous attempts in two significant ways. First, I use enough heat and time to kill all microbes in the wine, and secondly I do it in the tank or barrel from which I intend to bottle the wine. In this way both the wine and the container holding the wine are sanitized.

### CROSS REFERENCE TO RELATED APPLICATIONS

Not Applicable.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable.

### BACKGROUND OF THE INVENTION

Attaining biological stability in wine has been a problem for winemakers for centuries. The main methods for preventing microbes from destroying wine have been the addition of chemicals such as sulphur dioxide and potassium sorbate and ultra filtration. These methods are less than satisfactory. Chemicals can only be used to a certain level before they affect the taste of the wine or cause allergy reactions in the drinker. Ultra filtration will remove the microbes but it also removes taste and body from the wine.

Previous attempts at pasteurization of wine have been marginally successful because of the subsequent spoilage of the wine in less than optimum winery storage and less than total kill of the microbes (1). Wines that had been heated to a point that the cell count of the microbes in the wine were less than 1 cell per milliliter degraded to between 200 and 1540 cells per milliliter within 6 months of treatment and storage in a winery tank.

### BRIEF SUMMARY OF THE INVENTION

I have devised a method to eliminate these problems and have the wine ready to bottle in a pasteurized state, and designed the equipment to do this in the winery. The method consists of two elements which differ from previous attempts in two significant ways (1, 2). First, I use enough heat and time to kill all microbes in the wine, and secondly I do it in the tank or barrel from which I intend to bottle the wine. In this way both the wine and the container holding the wine are sanitized.

### BRIEF DESCRIPTION OF THE SEVERAL VIEWS OF THE DRAWINGS

PLATE 6 is a photograph of the water bath pasteurizer assembled.

FIG. 1 is a plot of the temperature of a 55 gallon barrel of Vidal Blanc over time during pasteurization on Jul. 12, 2010. This drawing is illustrative of the theory of pasteurization described in the specification.

PLATE 1 contains photographs of the cultures taken before and after pasteurization of 55 gallons of 08 Vidal Blank on Jun. 9, 2010. Pasteurization took 32 hrs using the small capacity proof of concept microwave pasteurizer shown in PLATE 2.

PLATE 2 is a photograph of the microwave pasteurizer. The throughput of this pasteurizer is not high enough for production pasteurization, but it did provide a good proof of concept.

PLATE 3 contains photographs of the before and after cultures taken on the pasteurization of 55 gallons of Vidal Blanc on Apr. 12, 2010.

PLATE 4 contains photographs of the before and after cultures taken on the pasteurization of 55 gallons of VIDAL Blanc on Apr. 22, 2010.

PLATE 5 is a photograph of the water bath pasteurizer disassembled. This pasteurizer is more suited to production since the throughput is significantly higher than the microwave unit.

PLATE 7 contains photographs of the before and after cultures taken on the pasteurization of 55 gallons of Vidal Blanc with the water bath pasteurizer on Sep. 5, 2010.

### DETAILED DESCRIPTION OF THE INVENTION

Wine that is chemically stable and clear is moved to the tank or barrel where it is heated to a level that upon heating and cooling will produce a clear culture (PLATE 1). This is achieved in the following manner.

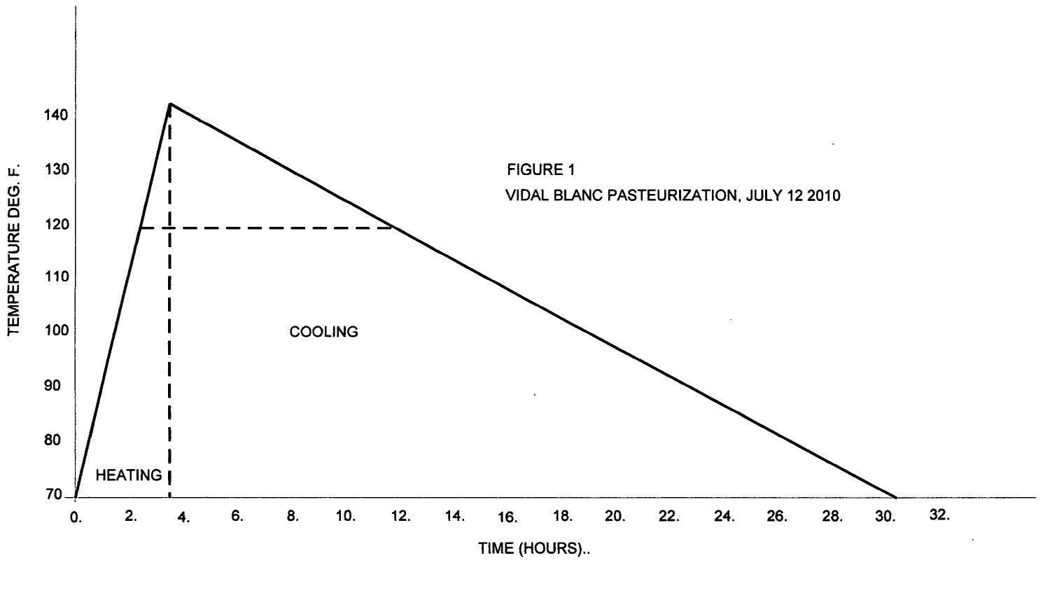

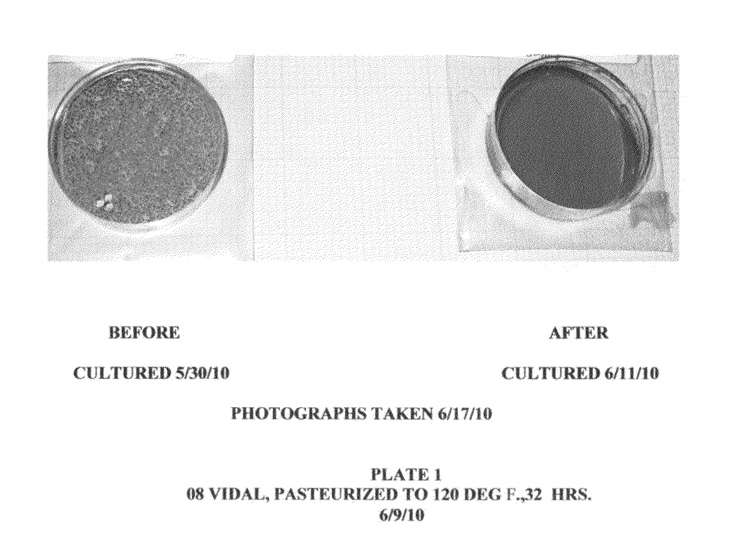

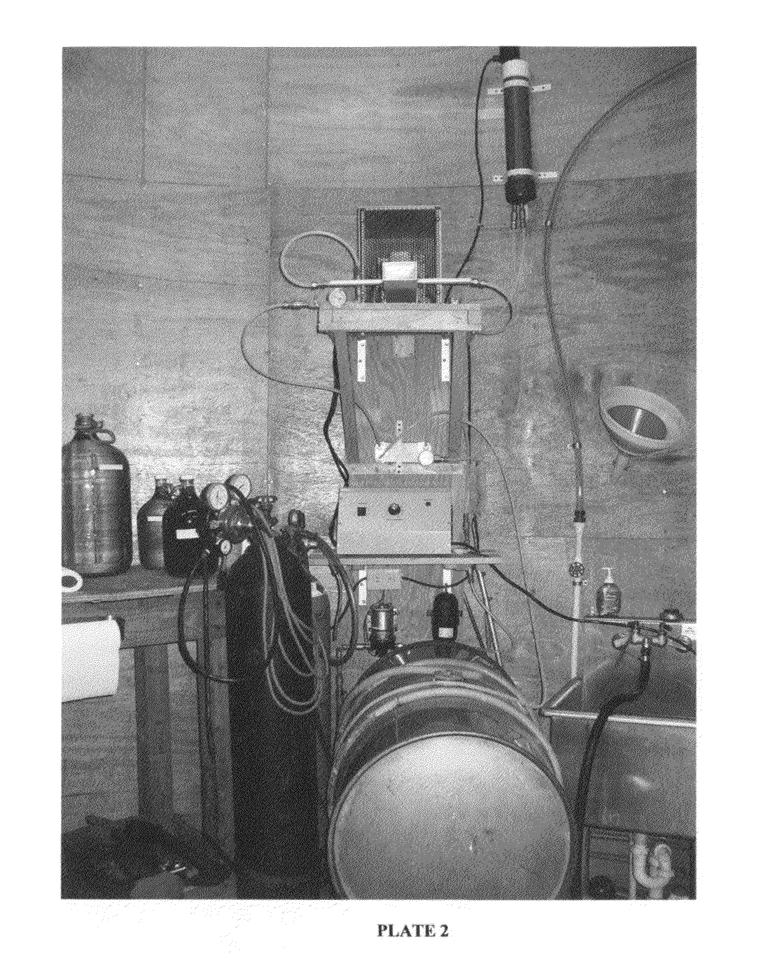

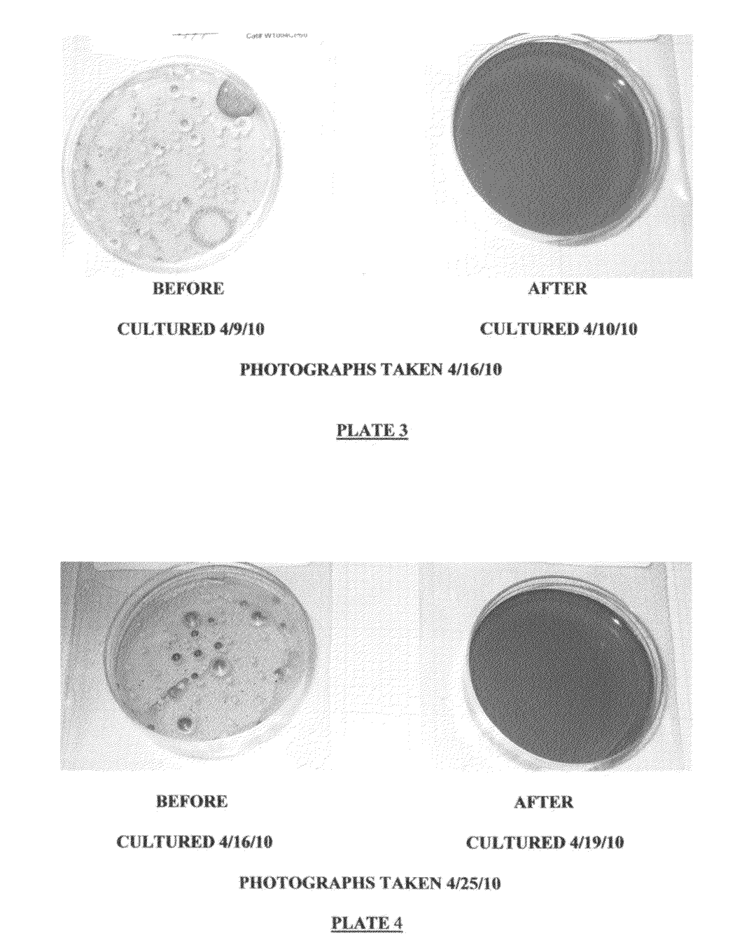

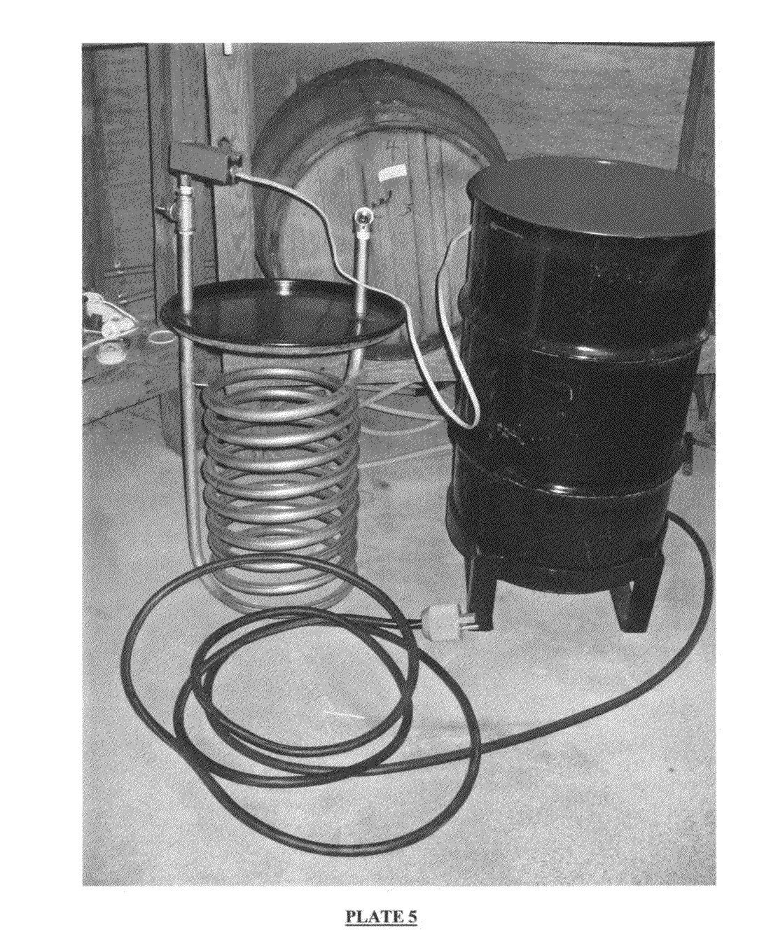

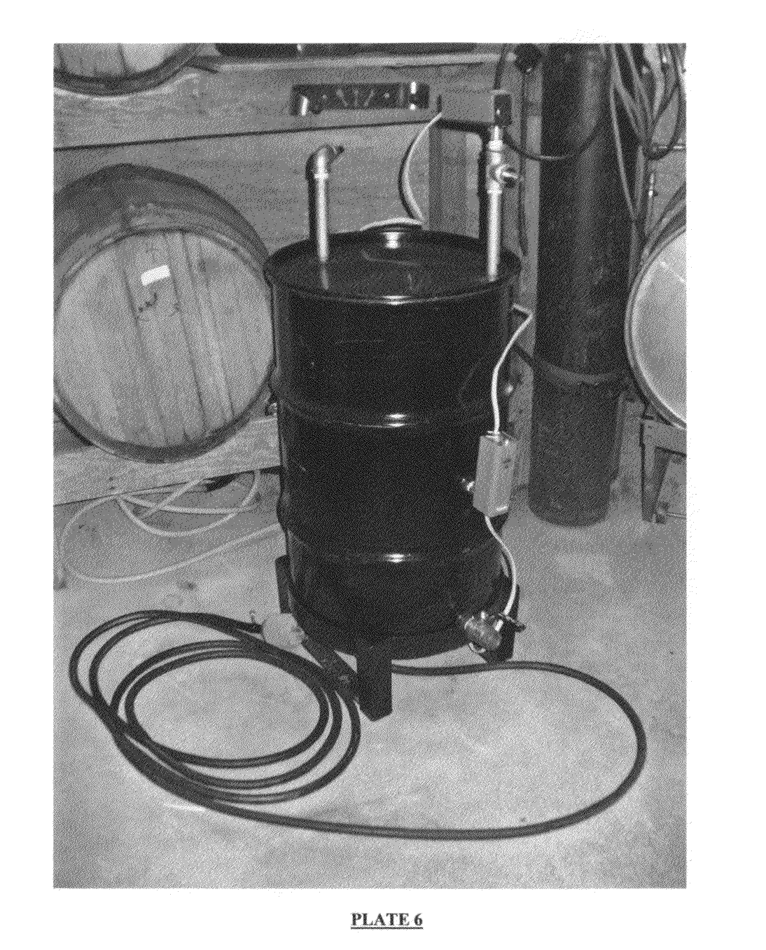

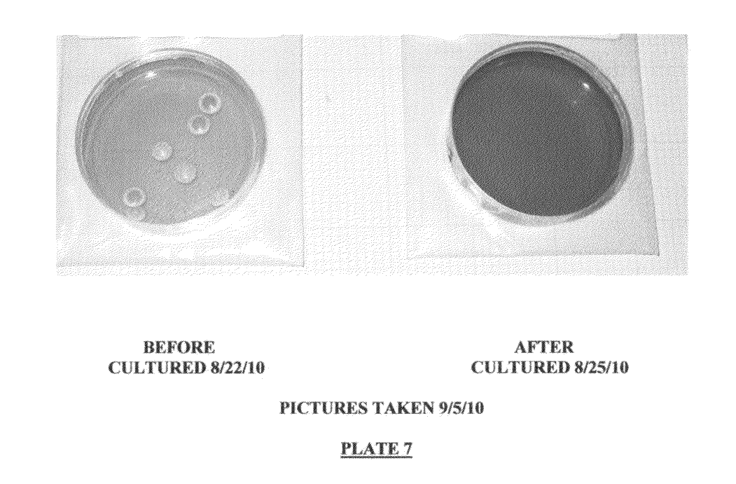

A wine pasteurization unit has been defined as heating to a constant temperature of 60 deg. C. or 140 deg. F. for 1 minute. This will kill enough bacteria and yeast to achieve the low but not full kill on the microbes and is usually in the range of less than 1 minute to several minutes (1, 2). However, if the wine is heated to something in the range of 120 to 140 deg. F., over a longer period of time and then allowed to air cool many more pasteurization units will be available. This can be illustrated by the analysis of the pasteurization of 55 gallons of Vidal Blanc in a 55 gallon stainless steel barrel on Jul. 12, 2010. FIG. 1 is a plot of the temperature of the barrel; over time.

1 Pasteurization Unit=1 PU=60 deg C. (1 min.)=140 deg. F. (1 min)=140 deg. F. min

The area under the heating section of the curve represents the heat applied to the barrel, and it is designated by H:

H=½(72 deg F.)(210 min.)=7350 deg F. min

C represents the heat remaining in the barrel while it air cools.

C=½(72 deg F.)(1650 min.)=59400 deg F. min

The total heat in the barrel during heating and cooling is the sum of H plus C. The total number of pasteurization units applied in this manner can be calculated in the following manner.

#PU=H+C/1 PU=7350 deg F. min+59400 deg F. min/140 deg F. min=477 PU

Testing has shown that any temperature below 120 deg F. does little to kill microbes, so let us discard all temperatures below 120 deg f. Then,

H=½(22 deg F.)(55 min)=605 deg F. min

C=½(22 deg F.)(538 min)=5918 deg F. min

#PU=(605 deg F. min)+(5918 deg F. min)/140 deg F. min=47 PU.

This figure is 30-40 times the # pasteurization units cited in the literature (1, 2) and results in the consistent total kill represented by the cultures in the plates which are in the back of this paper.

The next question which must be answered is: Does this treatment affect the wine? Refer to Table 1.

TABLE 1
Comparison of Vidal Blanc Before And After
Pasteurization on Several Occasions

| Attribute | As Is | Apr. 12, 2010 | Apr. 22, 2010 | Jun. 9, 2010 |
|---|---|---|---|---|
| Color | Good | Good | Good | Good |
| Taste | Good | Good | Good | Good |
| Aroma | Good | Good | Good | Good |
| PH | 3.69 | 3.65 | 3.65 | 3.65 |
| Ta | 0.68% | 0.68% | 0.68% | 0.68% |
| CO2 | 1020 mg/l | 222 mg/l | 130 mg/l | 370 mg/l |
| SO2 | 100 ppm | 30 ppm | 40 ppm | 25 ppm |
| Alcohol | 11.4% | 10.9% | 11.1% | 11.4% |
| Culture | TNTC* | Clear | Clear | Clear, |
| | | Plate 3 | Plate 4 | Plate 1 |

*TNTC = Too Numerous To Count

Most attributes in table 1 are within the normal accuracy of the measurements. The slight drop in PH can be attributed to the reduction if gas in the wine. Alcohol seems to drop off slightly on extremely long heating times. On Apr. 12 heating took 32 hours with a 1 KW unit. On Apr. 22 heating took 26 hours with the same unit. No significant change has occurred in the pasteurized wine.

Wine can not be directly heated because the wine can not tolerate temperatures over 170 deg. F. lest alcohol boil off. This eliminates the use of any direct heating. This also makes the use of steam in heat exchangers tricky because wine at the steam-wine exchanger wall interface will be at above 170 deg F. at some point and will volatize. I have therefore focused on two methods of application of this principal. The first pasteurization unit built is a 1 KW microwave unit shown in PLATE 2. The next generation pasteurizer is a water bath heated by an electric water heater element and necessary controls. It is shown in Plates 5 and 6. The major drawback in the microwave system was the low power and thus the low flow rate and the time necessary to achieve pasteurization temperatures. The water bath unit is higher power, allowing higher flow rates and thus shorter heating times.

Examine PLATE 2. The power supply and microwave unit were designed and constructed specifically to heat wine by Microwave Research Corporation in Laurel Md. The ancillary equipment installed was put in to accommodate the extremely low flow rates achievable with a 1 KW machine. These include a small diaphragm pump, a pulsation absorber necessary with this type pump, a gravity feed chamber with a switch and relay to control the pump, a needle valve to further restrict flow, and a small heat exchanger to heat incoming wine and thus take some load off the microwave. This machine is not good as a production unit. It did, however, provide a good proof of concept. See PLATES 1, 3 and 4.

Examine PLATES 5 and 6. These plates show the water bath pasteurizer apart (PLATE 5) and together (Plate 6). Note the two thermostats. One thermostat is set at 140 degrees F. and is on the return to the unit from the tank being pasteurized. Thus, when the return to the heater reaches 140 degrees F., the heater is turned off. The second thermostat is in the water bath and will shut down the heater when the water bath reaches 165 degrees F. PLATE 5 shows the coil in the water bath which contains the wine flowing through the water bath. The water bath consists of a 30 gallon barrel with a 5500 watt electric heater in the bottom controlled by a 25 amp contactor and the two thermostats. PLATE 7 shows the results of pasteurization in the water bath pasteurizer on Aug. 22, 2010.

### REFERENCES

(1) P. Ribereau-Gayon, Y. Glories, A. Maujean and D. Dubourdieu, Handbook of Enology, Volume 1, Section 9-4, “Destruction of Yeasts by Heat (Pasteurization)”
(2) Same, Volume 2, Section 12-2, “Heat Stabilization”
(3) D. F. Splittstoesser, L. L. Lienk, H. Wilkinson and J. R. Stamer, Applied Microbiology, 1975, September, pp 369-373.

1) I claim a method for the pasteurization of wine in the winery which will provide a Full kill of microbes in the wine and in the container holding the wine.

2) I claim a water bath pasteurizer that will execute this pasteurization with no adverse effect on the wine.
